(19) United States
(12) Patent Application Publication
(10) Pub. No.: US 2013/0133607 A1
(43) Pub. Date: May 30, 2013

(54) STRUCTURE OF BALANCE SHAFT

(71) Applicant: Ahn LEE, Seoul (KR)

(72) Inventor: Ahn LEE, Seoul (KR)

(73) Assignee: Hyundai Motor Company, Seoul (KR)

(21) Appl. No.: 13/536,617

(22) Filed: Jun. 28, 2012

(30) Foreign Application Priority Data
Nov. 29, 2011 (KR) 10-2011-0126351

(51) Int. Cl. F02B 75/06

(52) U.S. Cl. 123/192.2

(57) ABSTRACT

A balance shaft structure for offsetting a secondary unbalance force due to a crankshaft of an engine may include a plurality of balance shafts rotating with the crankshaft, and a balance weight formed on a circumferential surface of each corresponding balance shaft and offsetting the secondary unbalance force, wherein the balance shafts may be disposed at the left and right of the crankshaft respectively and symmetric with respect to a longitudinal axis of the crankshaft, and disposed to be biased at a front part or a rear part of the engine, such that the center of weight may be offset by the center of weight of the engine, and a moment balance weight formed to each corresponding balance shaft and offsetting a pitch moment of the crankshaft generated by offsetting.

### CROSS-REFERENCE TO RELATED APPLICATION

The present application claims priority to Korean Patent Application No. 10-2011-0126351 filed in the Korean Intellectual Property Office on Nov. 29, 2011, the entire contents of which is incorporated herein for all purposes by this reference.

### BACKGROUND OF THE INVENTION

1. Field of the Invention

The present invention relates to a balance shaft structure, and more particularly, to a balance shaft structure that is mounted on the I4 engine of a vehicle, and can improve NVH (Noise Vibration Harshness) of the engine and reduce the weight of the engine.

2. Description of Related Art

In general, for the balance shaft of the I4 engine, one balance shaft is mounted at the left and right of the engine, respectively, that is, a total of two balance shafts are mounted on the purpose of offsetting a reciprocating secondary excitation force and rotate at a double speed together with a crankshaft in the opposite directions by the operation of a gear or a chain.

In this configuration, when the center of mass of the balance weight of the balance shaft is offset from the center portion of the engine, an unbalance pitch moment is generated by the balance shaft, such that, as shown in FIG. 1, there is a problem in that it needs to unnecessarily increase the length L of the balance shaft 6 in order to position the centers of the crankshaft 5 of the engine and the balance shaft 6 on the same line A. In more detail, according to the balancing theory of the I4 engine, the unbalance force is completely offset and the unbalance moment is not generated only when the position where an unbalance force of the balance shaft for offsetting the secondary excitation force of the I4 engine is generated accurately coincides with the center line of the engine. However, since transmission of a driving force of the balance shaft is generally implemented by driving gear/sprocket of the front part or the rear part of the engine, there was a problem in that the length L of the balance shaft 6 is unnecessarily increased, as shown in FIG. 1, in order to make the balance force of the balance shaft accurately coincide the center portion of the side view of the engine, which causes a problem in that the structure of the engine is complicated and the weight increases.

The balance shaft is mounted with side view offset at the front part or the rear part of the engine in some cases in order to prevent an unnecessary increase in length of the balance shaft. In this case, although the length can reduce, as shown in FIG. 2, the center of the balance shaft 6 and the center of the crankshaft 5 are not on the same line A, and accordingly, offset is generated in a secondary unbalance force C and a balancing force D. When the balance shaft is mounted with offset, as described above, there was a problem in that an unbalance pitch moment E is generated and the NVH (Noise Vibration Harshness) of the engine is deteriorated.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a balance shaft structure having advantages of simplifying the structure of an engine and reducing the weight by preventing an unnecessary increase in length of the balance shaft, and of reducing NVH (Noise Vibration Harshness) of the engine by offsetting an unbalance pitch moment.

In an aspect of the present invention, a balance shaft structure for offsetting a secondary unbalance force due to a crankshaft of an engine, may include a plurality of balance shafts rotating with the crankshaft, and a balance weight formed on a circumferential surface of each corresponding balance shaft and offsetting the secondary unbalance force, wherein the balance shafts are disposed at the left and right of the crankshaft respectively and symmetric with respect to a longitudinal axis of the crankshaft, and disposed to be biased at a front part or a rear part of the engine, such that the center of weight is offset by the center of weight of the engine, and a moment balance weight formed to each corresponding balance shaft and offsetting a pitch moment of the crankshaft generated by offsetting.

The plurality of balance shafts may include first and second balance shafts disposed at both sides of the crankshaft, the first and second balance shafts having the same shape and being disposed on the same imaginary plane.

Each moment balance weight may include a first moment balance weight and a second moment balance weight, wherein the first moment balance weight and the second moment balance weight are disposed to may have a phase difference of 180°.

The first moment balance weight, the balance weight, and the second moment balance are disposed in series on corresponding balance shaft.

The first moment balance weight and the balance weight are disposed to may have the same phase angle.

The first moment balance weight and the second moment balance weight are formed in disc shapes having a semicircular cross-section and a predetermined thickness.

The first moment balance weight integrally extends from the balance weight and the second moment balance weight is disposed to may have a phase difference of 180° from the first moment balance weight, wherein the first moment balance weight and the second moment balance weight are formed in disc shapes having a semicircular cross-section and a predetermined thickness.

The engine is an I4 engine.

The balance shafts are driven at a double speed of the rotation speed of the crankshaft while having a phase difference of 180° from the crankshaft.

The balance weight is a cylinder having a semicircular cross-section.

According to the balance shaft structure of the present invention, even though mounted at any one of the front part and the rear part of the engine, the balance shaft can reduce vibration and noise by offsetting the pitch moment, and accordingly, it is possible to reduce the length of the balance shaft, such that it is possible to reduce the weight and the size of the engine.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing an example of a balance shaft structure according to the related art.

FIG. 2 is a view showing another example of a balance shaft structure according to the related art.

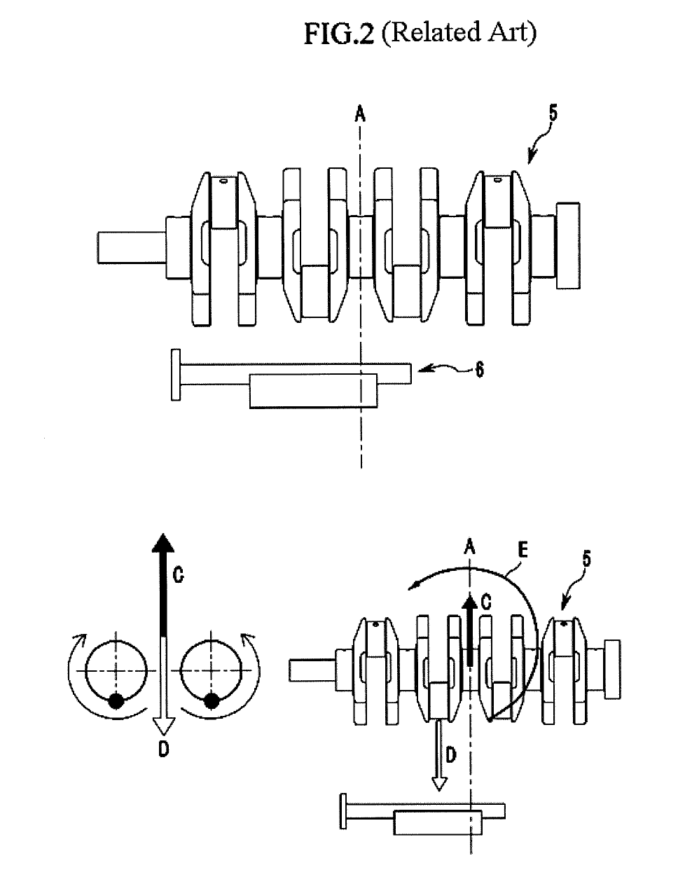

FIG. 3 is a view showing a balance shaft structure according to an exemplary embodiment of the present invention.

FIG. 4 is a diagram showing a connecting rod relating to a balancing theory.

FIG. 5 is a view showing the components of an unbalance force and an unbalance moment in an engine.

FIG. 6 is a view showing when a balance shaft structure according to an exemplary embodiment of the present invention is mounted at the front part of an engine.

FIG. 7 is a view showing when a balance shaft structure according to an exemplary embodiment of the present invention is mounted at the rear part of an engine.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, exemplary embodiments of the present invention are described with reference to the accompanying drawings.

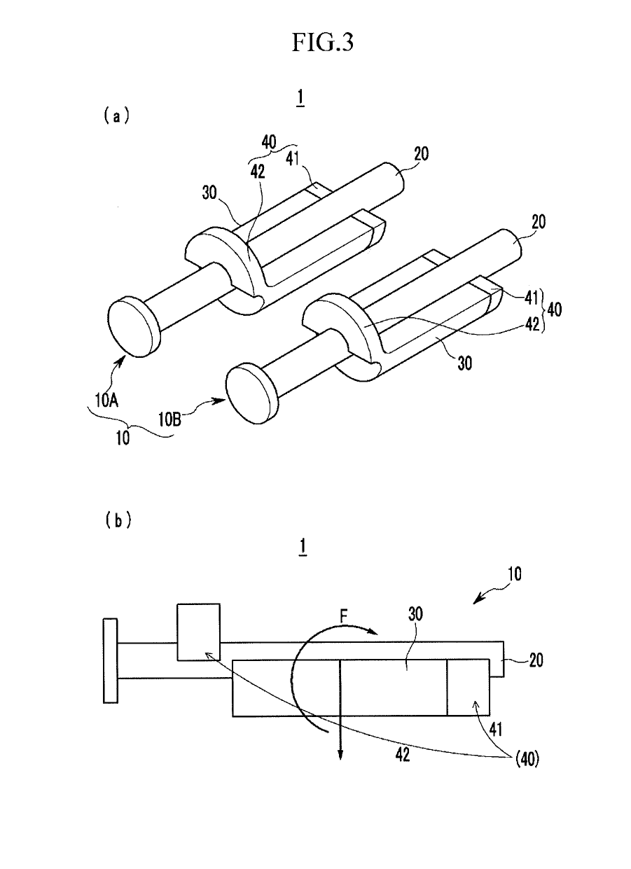

FIG. 3 (a) is a perspective view of a balance shaft structure 1 according to an exemplary embodiment of the present invention and FIG. 3 (b) is a cross-sectional side view of the balance shaft structure 1 according to an exemplary embodiment of the present invention.

As shown in FIG. 3 (a) or (b), the balance shaft structure 1 according to an exemplary embodiment of the present invention includes two balance shafts 10A and 10B, the balance shafts 10A and 10B each include a shaft 20 rotating with a crankshaft of an engine and a balance weight 30 formed on the outer circumferential surface of the shaft 20 to offset a secondary unbalance force, and the balance shafts 10A and 10B are biased and offset-mounted at the front part or the rear side of the engine, and a moment balance weight 40 is formed at the shaft 20 to offset a pitch moment due to the offset.

According to an exemplary embodiment of the present invention, a balancing moment F is generated in the opposite direction to the moment generated due to the offset by the moment balance weight 40, as shown in FIG. 3 (b).

In one or a plurality of exemplary embodiments, the engine where the balance shaft 1 according to an exemplary embodiment of the present invention may be an in-line 40 cylinder engine (I4 engine).

Since an up-down excitation secondary unbalance force is generated in the I4 engine, it is necessary to mount two balance shafts at both sides of the crankshaft in order to offset the up-down excitation secondary unbalance force. This is described hereafter.

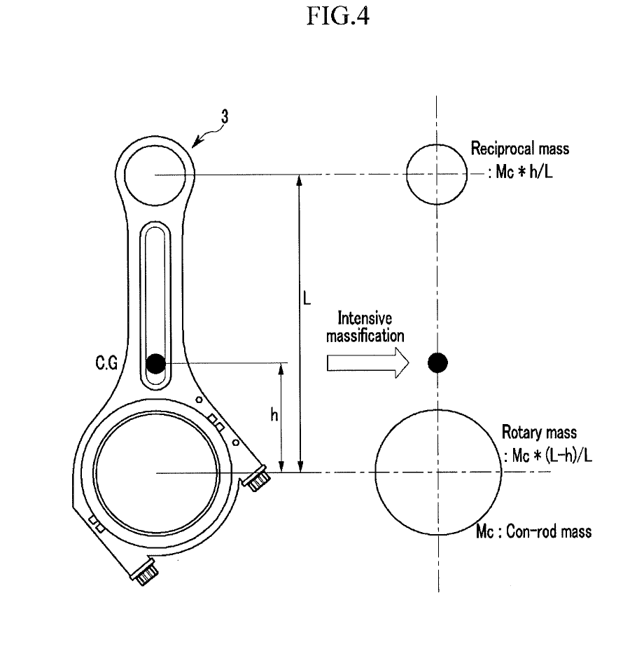

An engine is provided with a balancing design against an unbalance moment due to pistons making a reciprocal motion and a connecting rod making a pendulum motion. Intensive massification is considered to divide the connecting rod into a reciprocation mass component connected with the piston and a rotation mass component connected with a crankpin, and the division causes an inertia force when the engine is driven. Referring to FIG. 4, the inertia force of a reciprocal motion due to the component of a reciprocation mass Mo of the connecting rod 3 generates an inertia force in the same direction as the central axis of a cylinder and a rotational inertia force due to a rotary mass Mr generates an inertia force in the radial direction of a rotational motion.

The inertia force of a reciprocal motion and the inertia force of a rotating motion may be determined by the following equations

Reciprocal inertia force=MoRW²(cos θ+R/L cos 2θ)

Reciprocal inertia force=First inertial force(MoRW² cos θ)+Secondary inertia force(MoRW²R/L cos 2θ) (Equation 1)

Rotational inertia force=MrRW² (Equation 2)

Referring to FIG. 4, Mo is a reciprocal mass and can be obtained from Mc*h/L in Equation 1 and Equation 2, Mr is a rotary mass and can be obtained from Mc*(L−h)/L, Mc is the mass of the connecting rod, R is a crank radius (stroke/2), W is an angular speed, L is the length of the connecting rod, h is the distance from the rotary mass center of the connecting rod to the intensive equation center, and θ is a phase angle of the crank.

For the balancing design of the engine, it is possible to check whether an unbalance force and an unbalance moment of the engine are generated, by determining the vector components of the reciprocal first inertial force, secondary inertia force, and the rotational inertia force of Equation 1 and Equation 2 for the engine type and the phase angle of the crankshaft, and it is necessary to dispose a balancing structure that offsets the unbalance components in order to improve the NVH of the engine.

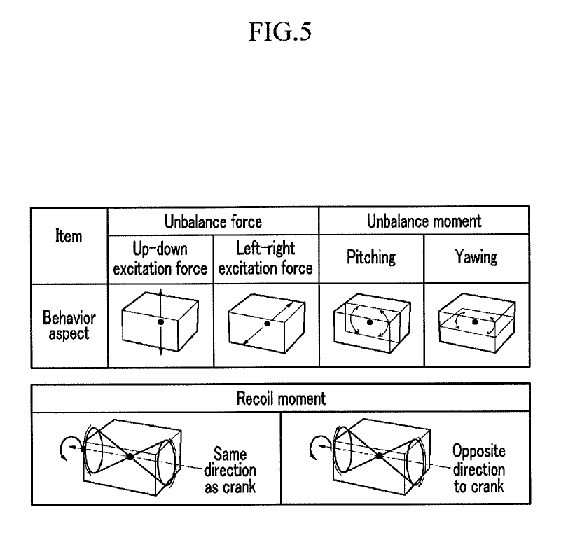

In general, as shown in FIG. 5, the components of the unbalance force of the engine are an unbalance force due to an up-down excitation force and an unbalance force due to a left-right excitation force, and the components of the unbalance moment are a pitching moment and a yawing moment.

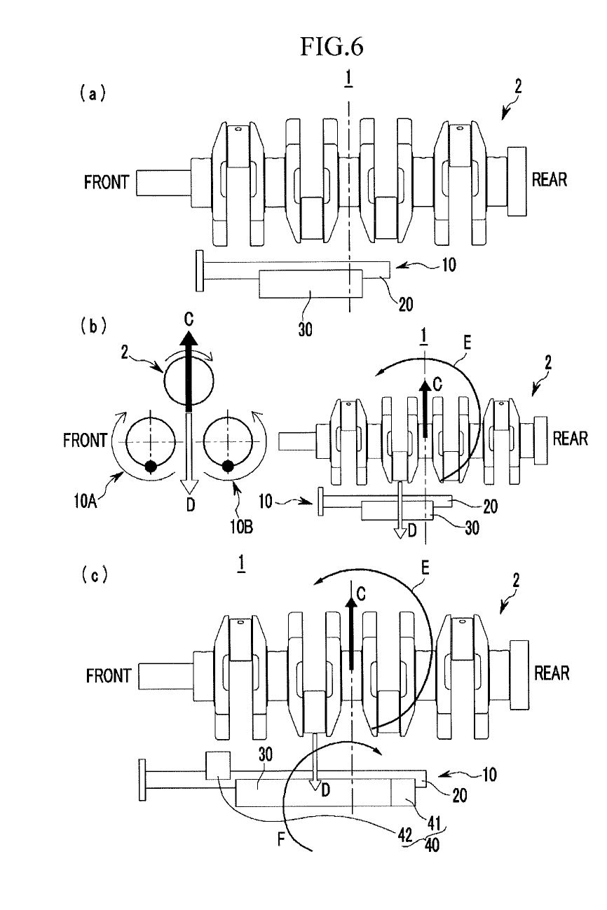

In particular, in the I4 engine according to an exemplary embodiment of the present invention, as shown in FIG. 6 (b), as a secondary unbalance force C is generated by an up-down excitation force, two balance shafts 10A and 10B are mounted at both sides of the crankshaft 2 to offset the secondary unbalance force C.

In more detail, the secondary unbalance force C due to the up-down excitation force of the I4 engine is 4Zo R/L cos 2θ. Where Zo=MoRW², Mo is a reciprocal mass, L is the length of the connecting rod length, W is an angular speed of the engine, and R is a crank radius.

The two balance shafts 10A and 10B are provided to offset the secondary unbalance force C due to the up-down excitation force.

In one or a plurality of exemplary embodiments, the balance shaft structure 1 may be composed of a first balance shaft 10A rotating at a double speed in the same direction as that of the crankshaft 2 and a second balance shaft 10B rotating at a double speed in the opposite direction to that of the crankshaft.

As the first balance shaft 10A and the second balance shaft 10B rotate at both sides of the crankshaft 2, a balance force D that is the resultant force offsets the secondary unbalance force C. Therefore, the first balance shaft 10A and the second balance shaft 10B each generate a balancing force, a half the second unbalance force C and the phase should be set to have a difference of 180° from the secondary unbalance force C.

The first and second balance shafts 10A and 10B include a balance weight 40 formed at the lower portion of the circumferential surface of the shaft 20 to form the phase difference of 180° from the secondary unbalance force C.

In one or a plurality of exemplary embodiments, as shown in FIG. 3 or FIG. 6, the balance weight may be a cylinder with a semicircular cross-section. Accordingly, the balancing force D that offsets the secondary unbalance force C is generated in rotation.

Further, the first balance shaft 10A and the second balance shaft 10B should have the same shape and should be disposed at the same position on the same plane at both sides of the crankshaft 2 in order to generate the balancing force D accurately in the opposite direction to the second unbalance force C by the resultant force of the first balance shaft 10A and the second balance shaft 10B.

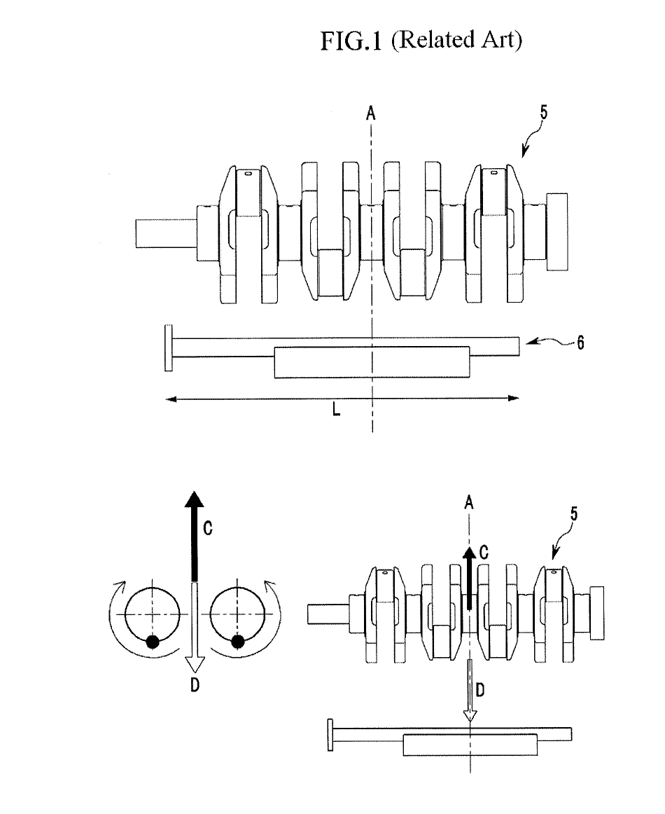

Meanwhile, as shown in FIG. 1, balance is accurately made only when the centers of the balancing force and the secondary unbalance force exist on the same line A even when the balance weight is seen from a side, such that it is possible to offset the secondary unbalance force without generating a moment. For this configuration, in the related art, the centers meet each other by increasing the length of the balance shaft disposed at the front part or the rear part of the engine, as shown in FIG. 1. However, there was a problem in the related art described above in that as the length of the balance shaft increases too much, the structure is complicated and the weight of the engine increases.

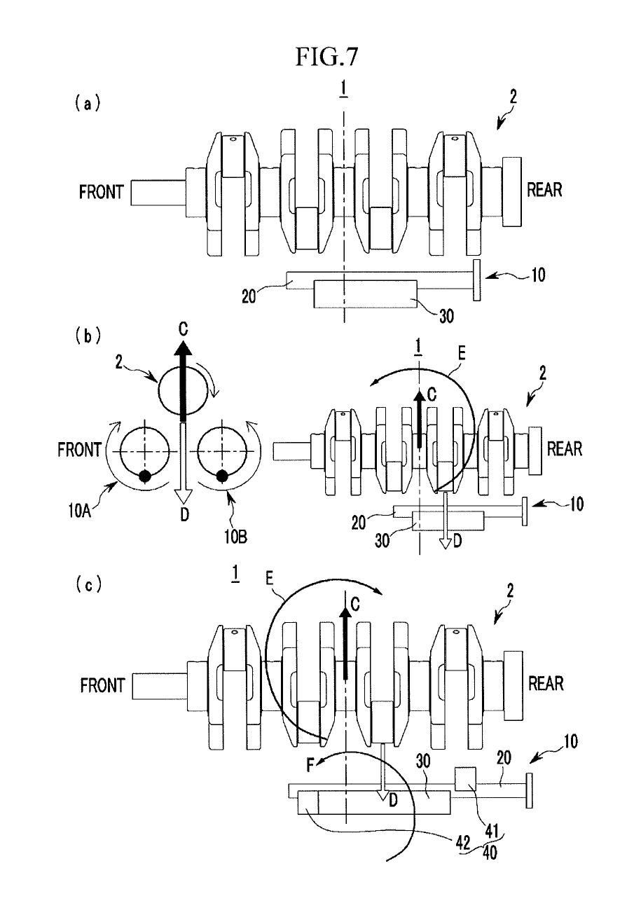

According to an exemplary embodiment of the present invention, as shown in FIG. 6 or 7, the balance shaft 10 is disposed at the front part or the rear side to be biased such that offset is generated from the center portion of the crankshaft 2 of the engine, without increasing the length of the balance shaft, unlike the related art. That is, according to an exemplary embodiment of the present invention, since the balance shaft 10 is offset-mounted such that the secondary unbalance force C and the balancing force D are not on the same line, a pitch moment E is generated in a predetermined direction, as shown in FIG. 6 or 7.

FIG. 6 is a view showing when a balance shaft 10 according to an exemplary embodiment of the present invention is offset-mounted at the front part of an engine.

As shown in FIG. 6 (b), a pitch moment E is applied counterclockwise to the crankshaft 2 by offset of the second unbalance force C and the balancing force D.

When the engine is driven in this state, there is a problem in that vibration and noise are generated by the pitch moment E and the NVH of the engine is deteriorated. Therefore, the balance shaft structure 1 according to an exemplary embodiment of the present invention is equipped with a moment balance weight 40 to offset the pitch moment E.

In one or a plurality of exemplary embodiments, as shown in FIG. 3 or FIG. 6, the moment balance weight 40 may be divided into a first moment balance weight 41 and a second moment balance weight 42, and the first moment balance weight 41 and the second moment balance weight 42 are disposed on the shaft 20 such that the phase difference becomes 180°.

Further, the first and second moment balance weights 41 and 42 are provided to the first balance shaft 10A and the second balance shaft 10B, respectively, in the same way.

As shown by the exemplary embodiment in FIG. 6 (c), as the first and second moment balance weights 41 and 42 are disposed on the shaft 20 of the balance shaft 10, a couple moment F is generated clockwise, in the opposite direction to the pitch moment E, and offsets the counterclockwise pitch moment E generated in the crankshaft 2.

Therefore, according to the exemplary embodiment of the present invention, the pitch moment E generated by offset-mounting the balance shaft, is offset by the couple moment F of the moment balance weights, vibration and noise generated when the engine is driven are reduced and the NVH of the engine is improved.

Further, the first moment balance weight 41 and the second moment balance weight 42 are mounted on the shaft 20 such that the phase difference becomes 180°, such that the magnitude of the balancing force D does not change.

In one or a plurality of exemplary embodiments, the first moment balance weight 41 and the second moment balance weight 42, as shown in FIG. 3, may be formed in disc shapes having a semicircular cross-section and a predetermined thickness. Further, as shown in FIG. 3, the first moment balance weight 41 may be integrally formed by extending from the balance weight 30 that is a cylinder having a semicircular cross-section and formed at the lower portion of the shaft 2 and the second moment balance weight 42 may be formed at the upper portion of the shaft 20 to have a phase difference 180° from the first moment balance weight 41.

According to this configuration, the force by the first moment balance weight 41 and the force by the second moment balance weight 42 act in the opposite directions and offset each other, when the balance shaft 10 rotates, such that the forces do not influence the magnitude of the balancing force D. This is because the balance force D should not be changed by the first and second moment balance weights 41 and 42, since the balancing force D is generated in the same magnitude as the secondary unbalance force C and accurately offsets the secondary unbalance force C, as shown in FIG. 6 (b).

Therefore, according to the balance shaft structure 1 according to an exemplary embodiment of the present invention described above, the pitch moment E can be offset by the first and second moment balance weights 41 and 42, and accordingly, the magnitude of the balancing force D does not change, such that the balance shaft can be offset-driven under 100% balancing. Accordingly, it is possible to drive the balance shaft with the NVH of the engine improved, even without unnecessarily increasing the length of the balance shaft, unlike the related art.

FIG. 7 is a view showing a balance shaft structure according to an exemplary embodiment of the present invention.

As shown in FIG. 7, a balance shaft 10 of the present invention may be offset-mounted at the rear part, not the front part of an engine.

Even though mounted at the rear part, the basic shape or structure of the balance shaft 10 is the same as that when it is mounted at the front part.

However, as the balance shaft 10 is offset-mounted to be biased to the rear part of the engine, as shown in FIG. 7, it is different that a pitch moment E is generated clockwise by offset of the secondary unbalance force C and the balancing force D.

A moment balance weight 40 is disposed on two balance shafts of a first balance shaft 10A and a second balance shaft 10B, respectively, disposed at both sides of a crankshaft 2 in order to remove the pitch moment.

In one or a plurality of exemplary embodiments, the moment balance weight 40 may be composed of a first moment balance weight 41 and a second moment balance weight 42, and the first moment balance weight 41 and the second moment balance weight 42 may be formed on or integrally with the shaft 20 with a phase difference of 180°.

According to the exemplary embodiment shown in FIG. 7, the first moment balance weight 41 integrally extends from the balance weight 10, at the lower left of the shaft 20. Further, the second moment balance weight 42 is formed at the right upper portion of the shaft 20.

A couple moment F is generated counterclockwise in the balance shaft 10 by the weight of the first and second moment balance weights 41 and 42 and offsets the pitch moment E.

Further, the first moment balance weight 41 and the second moment balance weight 42 generates forces in the opposite direction by the phase difference of 180° in rotation and the forces offset each other, thereby not changing the balancing force D.

Therefore, the balance shaft structure 1 according to an exemplary embodiment of the present invention offsets the pitch moment E when being offset-mounted not only at the front part, but at the rear part of the engine, such that it is possible to reduce vibration and noise, and since it does not need to unnecessarily increase the length of the balance shaft 10, it is possible to reduce the weight and the size of the engine.

For convenience in explanation and accurate definition in the appended claims, the terms “upper”, “lower”, “inner” and “outer”, are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A balance shaft structure for offsetting a secondary unbalance force due to a crankshaft of an engine, the structure comprising:
a plurality of balance shafts rotating with the crankshaft; and
a balance weight formed on a circumferential surface of each corresponding balance shaft and offsetting the secondary unbalance force,
wherein the balance shafts are disposed at the left and right of the crankshaft respectively and symmetric with respect to a longitudinal axis of the crankshaft, and disposed to be biased at a front part or a rear part of the engine, such that the center of weight is offset by the center of weight of the engine, and
a moment balance weight formed to each corresponding balance shaft and offsetting a pitch moment of the crankshaft generated by offsetting.

2. The structure of claim 1, wherein the plurality of balance shafts include first and second balance shafts disposed at both sides of the crankshaft, the first and second balance shafts having the same shape and being disposed on the same imaginary plane.

3. The structure of claim 1,
wherein each moment balance weight includes a first moment balance weight and a second moment balance weight, and,
wherein the first moment balance weight and the second moment balance weight are disposed to have a phase difference of 180°.

4. The structure of claim 3, wherein the first moment balance weight, the balance weight, and the second moment balance are disposed in series on corresponding balance shaft.

5. The structure of claim 3, wherein the first moment balance weight and the balance weight are disposed to have the same phase angle.

6. The structure of claim 3, wherein the first moment balance weight and the second moment balance weight are formed in disc shapes having a semicircular cross-section and a predetermined thickness.

7. The structure of claim 3, wherein the first moment balance weight integrally extends from the balance weight and the second moment balance weight is disposed to have a phase difference of 180° from the first moment balance weight.

8. The structure of claim 7, wherein the first moment balance weight and the second moment balance weight are formed in disc shapes having a semicircular cross-section and a predetermined thickness.

9. The structure of claim 1, wherein the engine is an I4 engine.

10. The structure of claim 1, wherein the balance shafts are driven at a double speed of the rotation speed of the crankshaft while having a phase difference of 180° from the crankshaft.

11. The structure of claim 1, wherein the balance weight is a cylinder having a semicircular cross-section.
